(19) United States
(12) Patent Application Publication
(10) Pub. No.: US 2011/0216102 A1
(43) Pub. Date: Sep. 8, 2011

(54) METHOD AND APPARATUS FOR REDUCING POWER CONSUMPTION IN ELECTRONIC DEVICE

(75) Inventor: Ji-Young KIM, Suwon-si (KR)

(73) Assignee: SAMSUNG ELECTRONICS CO. LTD., Suwon-si (KR)

(21) Appl. No.: 13/035,109

(22) Filed: Feb. 25, 2011

(30) Foreign Application Priority Data
Mar. 2, 2010 (KR) 10-2010-0018401

(51) Int. Cl. G09G 5/10; G09G 5/00

(52) U.S. Cl. 345/690; 345/212

(57) ABSTRACT

A method and an apparatus for reducing power consumption in an electronic device that supports an Active Matrix Organic Light Emitting Diode (AMOLED) are provided. In the method, a color value to be displayed is determined for each pixel of a screen. A brightness value of a color value corresponding to a color section set in advance among color values of respective pixels are changed. After the brightness values are changed, a screen display is performed by spontaneously emitting light depending on the color value of each pixel.

### PRIORITY

This application claims the benefit under 35 U.S.C. §119(a) of a Korean patent application filed on Mar. 2, 2010 in the Korean Intellectual Property Office and assigned Serial No. 10-2010-0018401, the entire disclosure of which is hereby incorporated by reference.

### BACKGROUND OF THE INVENTION

1. Field of the Invention

The present invention relates to a method and an apparatus for reducing power consumption in an electronic device. More particularly, the present invention relates to a method and an apparatus for reducing power consumption in an electronic device that supports an Active Matrix Organic Light Emitting Diode (AMOLED).

2. Description of the Related Art

Since power of a mobile terminal is limited, it is important to minimize power consumption in order to use the mobile terminal for a long time while using the limited power.

Recently, compared to a Liquid Crystal Display (LCD), an Active Matrix Organic Light Emitting Diode (AMOLED), which is a self luminous display device, has an excellent brightness characteristic and a viewing angle characteristic, and thus has evolved as a next generation display device. Accordingly, use of a mobile terminal that uses the AMOLED has gradually increased.

Since the AMOLED is greatly influenced by brightness, an amount of power consumption changes depending on color to be expressed. That is, when expressing color close to a white color, the AMOLED consumes more power. When expressing color close to a black color, the AMOLED consumes less power. A difference between power consumption when the AMOLED expresses the white color and power consumption when the AMOLED expresses the black color is 10 times at the maximum.

Accordingly, a terminal that supports the AMOLED has recently refrained from expressing white color for each operating system and each application. For this purpose, a task of having to newly configure a user interface for each operating system or each application is required. That is, software used for a mobile terminal that supports a conventional Thin Film Transistor (TFT) LCD cannot be used without modification.

Therefore, a need exists for an alternative for reducing power consumption of the AMOLED regardless of software being applied to a mobile terminal.

### SUMMARY OF THE INVENTION

An aspect of the present invention is to address at least the above-mentioned problems and/or disadvantages and to provide at least the advantages described below. Accordingly, an aspect of the present invention is to provide a method and an apparatus for reducing power consumption in an electronic device.

Another aspect of the present invention is to provide a method and an apparatus for reducing power consumption in an electronic device that supports an Active Matrix Organic Light Emitting Diode (AMOLED).

Still another aspect of the present invention is to provide a method and an apparatus for reducing power consumption by changing a brightness level depending on color in an electronic device that supports an AMOLED.

In accordance with an aspect of the present invention, a method for reducing power consumption in an electronic device that supports an AMOLED is provided. The method includes determining a color value to be displayed for each pixel of a screen, changing a brightness value of a color value corresponding to a color section set in advance among color values of respective pixels, and after changing the brightness value, spontaneously emitting light depending on the color value of each pixel to perform a screen display.

In accordance with another aspect of the present invention, an apparatus for reducing power consumption in an electronic device is provided. The apparatus includes a controller for determining a color value to be displayed for each pixel of a screen, a filter for changing a brightness value of a color value that corresponds to a color section set in advance among color values of the respective pixels, and an AMOLED for spontaneously emitting light depending on the color value of each pixel provided from the filter to perform a screen display.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating an electronic device according to an exemplary embodiment of the present invention; and

FIG. 2 is a flowchart illustrating a procedure for changing a brightness level depending on color in an electronic device according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide a method and an apparatus for reducing power consumption by changing a brightness level depending on color in an electronic device that supports an Active Matrix Organic Light Emitting Diode (AMOLED).

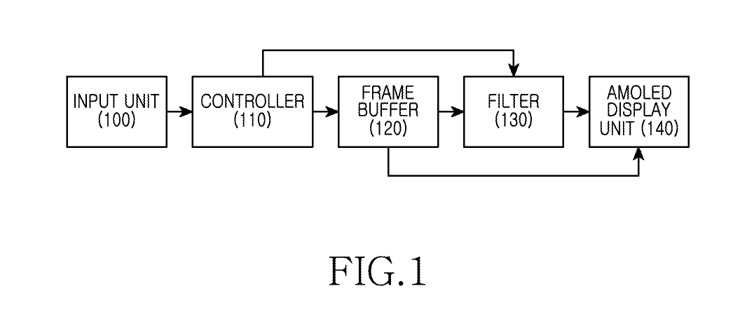

FIG. 1 is a block diagram illustrating an electronic device according to an exemplary embodiment of the present invention.

Referring to FIG. 1, the electronic device includes an input unit 100, a controller 110, a frame buffer 120, a filter 130, and an AMOLED display unit 140.

The input unit 100 receives data from a user and provides the data to the controller 110. The input unit 100 includes at least one of a function key, a numerical key, and a letter key. The input unit 100 may be a keypad that provides data corresponding to a key pressed by a user to the controller 110, or a touch sensor that recognizes a coordinate and a touch motion corresponding to a user's touch and provides the same to the controller 110. The input unit 100 receives a key or menu selection for a low power consumption mode entry or a low power consumption mode ending from a user and provides the same to the controller 110.

The controller 110 performs a control and a process for an overall operation of the electronic device. When a low power consumption mode entry event occurs, the controller 110 controls and processes a function for changing a brightness level of color to be displayed on a screen. That is, when the low power consumption mode entry event or the low power consumption mode ending event occurs, the controller 110 provides a signal informing entry to or ending of the low power consumption mode to the frame buffer 120 and the filter 130. In addition, the controller 110 determines color information to be displayed on each pixel of the screen depending on a currently executed operating system or application, and provides the same to the frame buffer 120.

The frame buffer 120 receives color information (for example, RGB information) of each pixel of the screen from the controller 110, temporarily stores the same, and provides the color information of the each pixel to the AMOLED display unit 140 or the filter 130 under control of the controller 110. That is, the frame buffer 120 provides the color information of the each pixel to the filter 130 from a point at which a signal informing that a low power consumption mode entry is input from the controller to a point at which a signal informing that a low power consumption mode ending is input, and provides the color information of each pixel to the AMOLED display unit 140 during other time sections.

The filter 130 changes and outputs the brightness levels of color information corresponding to a preset color section under control of the controller 110. That is, when a signal informing that a low power consumption mode entry is input from the controller 110, the filter 130 receives color information of each pixel of the screen from the frame buffer 120, and changes a brightness level for color information corresponding to a preset color section set in advance among the color information according to a scheme set in advance. Here, the preset color section may be set to include only white color having a highest brightness value or color of white series. For example, in an RGB model, the preset color section may be set as ‘R:255, G:255, B:255’ or ‘R:245˜255, G:245˜255, B:245˜255’. That is, when the color information of a pixel A is ‘R:255, G:255, B:255’, the filter 130 may switch an original color to a darker color by changing the brightness value of the pixel A into a value smaller than the original brightness value. Here, the brightness value for the color information may be changed into a value set in advance, or may be changed into a value obtained by subtracting a preset value from the original brightness value.

Here, the filter 130 may change a brightness level of a different color and not a color of the white color series depending on a designer's intention.

The AMOLED display unit 140 denotes an active type self luminous display device that uses a principle so that when a current flows through a fluorescence or phosphorescence organic thin film, an electron and a hole combine in an organic layer to generate light. The AMOLED display unit 140 receives color information of each pixel from the frame buffer 120 or the filter 130, and emits light according to color and brightness for each pixel to express relevant color on the screen.

Here, a case where the filter 130 exists between the frame buffer 120 and the AMOLED display unit 140, for example, has been described. However, the filter 130 may exist between the controller 110 and the frame buffer 120 to change the brightness level of each pixel transferred from the controller 110 to the frame buffer 120.

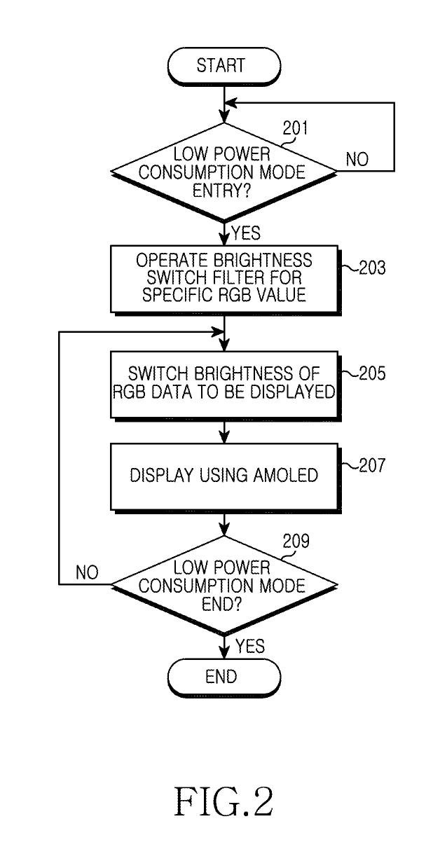

FIG. 2 is a flowchart illustrating a procedure for changing a brightness level depending on color in an electronic device according to an exemplary embodiment of the present invention.

Referring to FIG. 2, the electronic device determines whether a low power consumption mode entry event occurs in step 201. Here, the low power consumption mode entry event may occur through a key set in advance or menu setting, or may occur at a point at which a condition set in advance by a user is met. For example, the low power consumption mode entry event may occur when a hot key is pressed, when a remaining power amount of the electronic device is less than a threshold, or when a time set in advance arrives.

When the low power consumption mode entry event occurs, the electronic device operates a filter that changes the brightness level of a specific RGB value in step 203, and changes the brightness level of an RGB value that falls on a preset range among RGB values of respective pixels to be displayed on a screen using the filter in step 205. For example, in a case where the preset range is ‘R:245˜255, G:245˜255, B:245˜255’, the electronic device may change the brightness values of RGB values corresponding to ‘R:245˜255, G:245˜255, B:245˜255’ among RGB values for respective pixels into values smaller than the original brightness values. For example, in a case where an RGB value of a pixel B is ‘R:248, G:255, B:253’, since the RGB value falls on the preset range, the filter switches the color into a darker color than the original RGB value by changing a brightness level of the pixel B. In a case where an RGB value of a pixel C is ‘R:155, G:255, B:230’, since the RGB value does not fall on the preset range, the filter directly outputs the color without changing a brightness of the pixel C. Here, the filter may change the brightness of a pixel that falls on the preset range into a value set in advance, and may change the brightness to a value obtained by subtracting a value set in advance from the original brightness value.

The electronic device performs the screen display using the AMOLED in step 207, and determines whether the low power consumption mode ending event occurs in step 209. Here, the low power consumption mode ending event may occur through a key set in advance or menu setting, or may occur at a point at which a condition set in advance by a user is met.

When the low power consumption mode ending event does not occur, the electronic device returns to step 205 to re-perform subsequent steps. When the low power consumption mode ending event occurs, the procedure of the electronic device ends.

Exemplary embodiments of the present invention provide a method for reducing power consumption without separately processing software by changing a brightness level depending on color in an electronic device that supports an AMOLED.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for reducing power consumption in an electronic device that supports an Active Matrix Organic Light Emitting Diode (AMOLED), the method comprising:
determining a color value to be displayed for each pixel of a screen;
changing a brightness value of a color value corresponding to a color section set in advance among color values of respective pixels; and
after changing the brightness value, spontaneously emitting light depending on the color value of each pixel to perform a screen display.

2. The method of claim 1, wherein the brightness value is changed to a brightness value smaller than a brightness value of a relevant color value.

3. The method of claim 2, wherein the brightness value is changed to a value set in advance.

4. The method of claim 2, wherein the brightness value is changed by subtracting a value set in advance from the brightness value of the relevant color value.

5. The method of claim 1, wherein the brightness value is changed by operating a filter.

6. The method of claim 1, further comprising determining whether a low power consumption mode entry event occurs,
wherein when the low power consumption mode entry event occurs, the changing of the brightness value is performed.

7. The method of claim 6, wherein the low power consumption mode entry event occurs through at least one of a hot key input, menu setting, and a point at which a condition set by a user is met.

8. The method of claim 1, further comprising maintaining a brightness value of a color value that does not fall on the color section set in advance among the color values of the respective pixels.

9. An apparatus for reducing power consumption in an electronic device, the apparatus comprising:
a controller for determining a color value to be displayed for each pixel of a screen;
a filter for changing a brightness value of a color value that corresponds to a color section set in advance among color values of the respective pixels; and
an Active Matrix Organic Light Emitting Diode (AMOLED) for spontaneously emitting light depending on the color value of each pixel provided from the filter to perform a screen display.

10. The apparatus of claim 9, wherein the filter changes the brightness value of a relevant color value to a value smaller than an original value.

11. The apparatus of claim 10, wherein the filter changes the brightness value of the relevant color value to a value set in advance.

12. The apparatus of claim 10, wherein the filter subtracts a value set in advance from the brightness value of the relevant color value.

13. The apparatus of claim 9, wherein the controller determines whether a low power consumption mode entry event occurs, and when the low power consumption mode entry event occurs, the controller controls the filter to change a brightness value.

14. The apparatus of claim 13, wherein the low power consumption mode entry event occurs through one of a hot key input, menu setting, and a point at which a condition set by a user is met.

15. The apparatus of claim 9, wherein the filter maintains a brightness value of a color value that does not fall on the color section set in advance among the color values of the respective pixels.
